(19) United States
(12) Patent Application Publication
(10) Pub. No.: US 2025/0077607 A1
(43) Pub. Date: Mar. 6, 2025

(54) ACCELERATED EXECUTION OF A WEB APPLICATION BY A TERMINAL FOR PLAYING BACK AUDIO-VISUAL CONTENT, THROUGH A GATEWAY

(71) Applicant: Orange, Issy-les-Moulineaux (FR)

(72) Inventors: Mathieu RIVOALEN, CHATILLON CEDEX (FR); Hervé MARCHAND, CHATILLON CEDEX (FR)

(21) Appl. No.: 18/817,162

(22) Filed: Aug. 27, 2024

(30) Foreign Application Priority Data
Aug. 28, 2023 (FR) FR2309007

(51) Int. Cl. G06F 16/957; H04L 43/0876

(52) U.S. Cl. CPC G06F 16/957; H04L 43/0876

(57) ABSTRACT

A method for executing, by a terminal, a web application whose set of associated resources is stored on a remote web server, the method including: detecting, by a gateway, a presence within the terminal of a call to the web application and identifying the remote web server; determining a time period corresponding to low traffic associated with the remote web server; downloading at least part of the set of resources during the time period by the gateway.

### CROSS-REFERENCE TO RELATED APPLICATIONS

This application claims foreign priority to FR2309007, filed Aug. 28, 2023. The contents of the priority application are incorporated by reference herein in its entirety.

### BACKGROUND

### Field

The present invention concerns the field of applications for the terminals for playing back content streams of the audio-video (or audio-visual) type. It particularly applies to terminals of the television or TV stick type.

### Description of the Related Technology

Many applications deployed on the terminals are web applications that is to say hosted on web servers and accessible using a browser or other native tool installed on the terminal.

The web servers are typically remote and accessible through a telecommunications network such as the Internet.

This architecture allows the owners of the applications to easily modify them and modify their content, without having to download a new version on the terminals.

These web applications allow the users of the terminals to access different services related to audio-video content: for example, these different applications each allow accessing content broadcast by distinct providers. For example, we can have applications related to television channels, radio stations, on-demand content services (such as Netflix™, Amazon Prime™, Spotify™, Youtube™, etc.).

When the user turns on their terminal, embedded software managing the man-machine interface will trigger requests to the servers where the applications are hosted for each application configured on the terminal.

These first requests aim to at least allow the display of a first content related to each application: this first content may only be an icon, but in some cases, the interface is configured to display dynamic content related to the application.

It follows that when the terminal is turned on, it will request the various servers to download the content related to the configured web applications.

However, switching on the content stream playback terminals responds to social behaviors. These can be based on general habits such as turning on the television set when arriving home at the end of the day. They can also be based on major events such as the broadcast of a sports competition, for example.

Turning on a large number of terminals in a short time window generates a large number of requests received by the servers, and their overload.

Furthermore, web technology implies that several successive requests may be necessary in order to recover all the elements that allow producing the content required for an application: for example a first request to a domain name system or DNS, a request to recover the main HTML page, then requests to recover the different elements referenced in this HTML page (images, Javascript code, etc.).

The terminals connected to the telecommunication network via an ADSL type access network are also penalized by the low speed of the uplink. The large number of requests (therefore in the uplink direction) to overloaded servers generates significant latency for launching the web application.

A solution to this problem may consist in oversizing the servers so that they can cope with the request points. Outside these peak periods, the servers are therefore necessarily underused.

Such a solution suffers from at least two major drawbacks.

First of all, with the number of terminals deployed and the number of applications configured on these terminals increasing, it is difficult to keep the sizing of the servers in line with the growing needs.

Above all, the oversizing of the servers is detrimental in terms of overall energy management. Such a solution therefore clearly goes against ecological policies and good energy management which are increasingly implemented throughout the world.

It is therefore necessary to find other solutions for improving the experience of the users of terminals when turning them on, while minimizing the energy impact.

### SUMMARY

For these purposes, it is proposed to intervene at the level of the gateways which allow the terminals to connect, via a telecommunications network, to the remote servers where web applications are hosted.

More specifically, according to a first aspect, the present invention can be implemented by a method for executing, by a terminal, a web application whose set of associated resources is stored on a remote web server, said method including steps of:
detecting, by a gateway, a presence within said terminal of a call to said web application and identifying said remote web server;
determining a time period corresponding to low traffic associated with said remote web server;
downloading at least part of said set of resources during said period by said gateway.

This transmission of the resource to the terminal is performed without requesting the remote web server. Thus, as will be seen later, the cost of downloading the resources is shifted to periods where the server load is both lower and less impactful for the execution of the web application. This access is thus accelerated, without the need to oversize the server or the other equipment.

According to preferred embodiments, the invention comprises one or several of the following characteristics which can be used separately or in partial combination with each other or in total combination with each other:
said method further comprises a step of intercepting, by said gateway, a request from said terminal to a resource among said at least part of said set of resources, and transmitting said resource corresponding to said request to said terminal.
said at least part of said set of resources is stored on an internal web server of said gateway. This allows better management of the resources within the gateway, by allowing management of the resources similar in terms of protocol depending on whether it is available on a remote web server or on a local web server (HTTP protocol, etc.).
said at least part of said set of resources is made up of static resources. As will be seen later, it is thus possible to only download the resources that are unlikely to change in the short term but to keep downloading the more dynamic resources in order to allow a good compromise between accelerating the execution and taking into account the dynamic nature of the web applications.
said traffic corresponds to a load of said remote web server.
said interception operates in collaboration with an application container deployed on said gateway in order to isolate the processing of said steps within said gateway. Better isolation of the proposed mechanism is thus obtained with the other functionalities of the gateway.
said detection comprises an analysis of previous requests from said terminal to a domain name system based on an application database.
interception comprises an analysis of a first request from said terminal intended for said domain name system, to determine whether said first request corresponds to said web application and, in this case, a storage of an IP address corresponding to said first request, and detection of said request from said terminal to said resource from said IP address.

These mechanisms allow the gateway to learn by itself the web applications to which the terminals wish to access without depending on their functionalities, such as for example self-learning mechanisms.

Another aspect of the invention concerns a gateway for executing, by a terminal, a web application whose set of associated resources is stored on a remote web server, said gateway including processing means adapted to:
detect a presence within said terminal of a call to said web application and identify said remote web server;
determine a time period corresponding to a low traffic associated with said remote web server;
download at least part of said set of resources during said period by said gateway;

According to preferred embodiments, the processing means can further be adapted to intercept a request from said terminal to a resource among said at least part of said set of resources, and transmit said resource corresponding to said request to said terminal. The gateway can also comprise one or several of the previously mentioned characteristics, which can be used separately or in partial combination with each other or in total combination with each other.

Another aspect of the invention concerns a computer program comprising code instructions which, when it is executed by a processor of a gateway, carries out the steps of the method as previously described.

Another aspect of the invention concerns a data medium on which at least one series of program code instructions has been stored for executing a method as previously described.

Other characteristics and advantages of the invention will appear upon reading the following description of one preferred embodiment of the invention, given by way of example and with reference to the appended drawings.

### BRIEF DESCRIPTION OF THE DRAWINGS

The appended drawings illustrate the invention:

FIG. 1 illustrates a telecommunications network allowing the implementation of a method according to embodiments of the invention;

FIG. 2 schematizes a functional architecture of a gateway according to embodiments of the invention;

FIG. 3 illustrates a timing diagram illustrating a method according to one implementation of the invention;

FIG. 4 illustrates one simplified example of recovery of the resources by the terminal according to one embodiment;

FIG. 5 represents a timing diagram illustrating one particular embodiment of a step of the method;

FIG. 6 illustrates functional software architecture of a gateway according to one embodiment.

### DETAILED DESCRIPTION OF CERTAIN ILLUSTRATIVE EMBODIMENTS

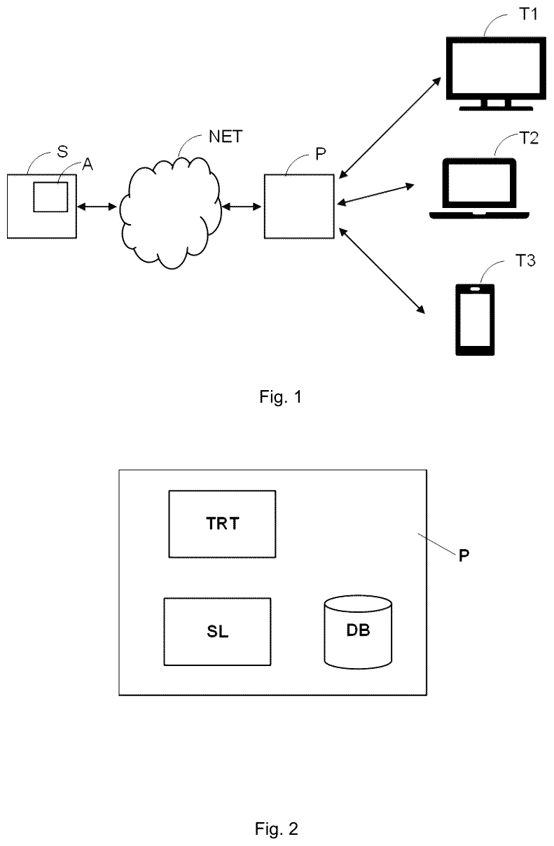

FIG. 1 illustrates a telecommunications network NET allowing a plurality of terminals or devices for playing back audio-visual content T1, T2, T3 to access and thus execute a web application A hosted on a remote server S.

These playback terminals or devices can be of different types, such as in particular a mobile terminal, a connected television set, a computer, a TV stick, etc.

The mobile terminal can be typically a Smartphone or a digital tablet, adapted to receive multimedia streams and to produce them on an interface of the terminal or connected to said terminal.

A television set can be natively connected or be connected through an associated device such as for example an HDMI stick connected to the television set.

A connected television or smart TV is a television set connected, directly or indirectly, to the Internet in order to provide a set of services to the viewers, including access to web applications.

As mentioned previously, these web applications allow the users to access different services related to audio-video content: for example, these different applications allow accessing content broadcast by different providers: it is for example possible to have applications related to television channels, radio stations, on-demand content services (such as Netflix™, Amazon Prime™, Spotify™, YouTube™, etc.).

External devices, or “TV sticks”, can connect to unconnected televisions in order to allow them to obtain identical functionalities or similar to connected televisions.

One example of an external device, or TV stick, communicating with a TV set may be Chromecast™. The Chromecast is a real-time multimedia stream player (multimedia gateway) developed and marketed by Google. The player plugs into the HDMI port of a television set and communicates, via Wi-Fi connection, with another player connected to the Internet (computer, Smartphone, tablet, etc.), in order to display on the television set the multimedia content received from an application compatible with Google Cast technology, from the Google Chrome browser present on a computer, or from some Android devices.

Connected televisions and TV sticks share the characteristic of being statistically turned on in similar time slots for a large number of people.

These time slots can for example correspond to the work rhythms of the majority of the population. Thus, statistically and depending on locations (countries, regions, cities, etc.), the population arrives home at the end of the day in a relatively short time window, and turns on their television in an even shorter time window.

Also, special events can turn on televisions and TV sticks in equally small time windows: for example before the start of a major sporting event (important football match, popular Olympic competition, etc.), or the like.

However, the method described is also likely to be applied to other types of terminals, including telephones or communication terminals of the Smartphone type, digital tablets, computers, etc.

The terminals are adapted to receive data streams corresponding to content selected by the users. This content can be associated with web applications: for example, a terminal will receive a data stream of a content selected through a web application corresponding to a given channel or on-demand content service.

These data streams can typically be multimedia streams. These typically comprise video or audio-video streams (or content). It can also be audio streams (music, radio broadcasts, etc.), or interactive content (including games). It can be on-demand content or “live” content. This mode of transmission can be a transmission mode of the “IPTV” (Internet Protocol Television) type, but other transmission modes can obviously be envisaged.

Typically, the terminals can connect to the public network (Internet, etc.) via a gateway P.

This gateway is typically a home gateway, which is computer equipment serving as an interface between the Internet (via an access network) and the home network. This type of gateway is also called “internet box”.

It is designed to ensure the data transmissions between the two networks in particular by carrying out the adequate protocol conversions. It typically proposes additional functionalities such as those of a router allowing the different terminals to constitute a home local area network (generally Wi-Fi), a firewall, etc.

The corresponding Wikipedia pages, for example, provide additional information on these gateways:
https://fr.wikipedia.org/wiki/Box_Internet
https://en.wikipedia.org/wiki/Residential_gateway

One example of gateway P is the Livebox™ from Orange.

FIG. 2 schematizes a high-level functional architecture of a gateway according to embodiments.

This gateway P comprises processing means, TRT, adapted to implement the method which will be described below, according to its different embodiments and its possible options. These processing means comprise, conventionally, at least one microprocessor, one memory designed to store a computer program including instructions implementing this method when it is executed by the at least one microprocessor. The processing means TRT can also include electronic circuits and other memories adapted to operate in collaboration with the at least one microprocessor.

The gateway can also include a local web server SL, a database DB, depending on different implementation options.

The gateway can also include different equipment and functionalities not directly related to the proposed method and which will therefore not be described.

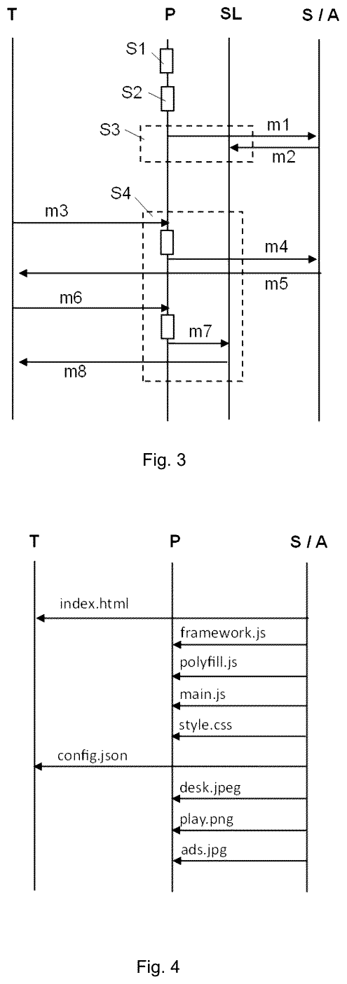

FIG. 3 illustrates, in the form of a timing diagram, one embodiment of a proposed method.

This method aims at the execution, by a terminal T (content playback), of a web application A located on a remote server.

This web application is associated with a set of resources stored on a remote web server, typically the one that hosts the web application. In the embodiment illustrated, it is assumed that the resources are co-located with the application A on the server S, without restriction of the generality of the method.

The method will be described for a terminal that triggers the execution of a web application. However, the method can be generalized to a plurality of terminals and for access to a plurality of web applications. Indeed, the same steps can be implemented for each execution by a terminal (among, possibly, a plurality) of a web application (among possibly a plurality).

The method comprises a first step of detecting, S1, by the gateway P, the presence, within the terminal T, of a call to the web application A and identifying the remote web server hosting the web application A.

This detection can be implemented according to different mechanisms.

According to one embodiment, the detection comprises an analysis of previous requests from the terminal T to a domain name system based on an application database.

A domain name system or DNS is a distributed computing service that associates Internet domain names with their IP addresses or other types of records.

More specifically, the domain name system can associate part of the identifier of a web application with an IP address.

For example, a web application can have as identifier www.monserveur.fr/monapplication, in which “www.monserveur.fr” forms a domain name and “monapplication” identifies the web application hosted on a server corresponding to this domain name.

The domain name system associates the domain name “www.monserveur.fr” with an IP address that corresponds to a given server.

This indirection allows making usable the public addresses (domain names) independent of the network infrastructure. It is thus possible to move the web application from one machine to another, without its “public address” changing.

The identifiers of the web applications can for example be URLs for “Unified Resource Locator”.

The applications database contains a set of web application identifiers likely to be used by a terminal. According to this embodiment, the detection step S1 comprises the identification of a subset of these applications which are actually used by the terminal T.

This application database can be filled in different ways.

In one embodiment, the gateway and the web applications are managed by the same operator. For example, Orange can provide a Livebox™ gateway and web applications for access to content channel packages. Other operators follow this same business model.

In such a situation, the gateway P can be easily configured by the operator itself with the identifiers of the web applications that it makes available to the terminals.

A public server can also be envisaged in which the various operators and web application providers would provide the identifiers of their web applications (for example in the form of a URL type address). The gateways P would then be suitable for downloading this database in order to know all the web applications likely to be installed by a terminal.

The gateway P can then analyze the previous requests by consulting a history, or log, stored in the memory of the gateway, of “Log” type.

According to another embodiment, the detection step S1 may not be based on a database of web applications likely to be used, but directly by providing applications installed on the terminal. There is then no need to analyze the previous requests.

For example, an interface can be proposed to allow the users to provide identifiers of the web applications they use so that these identifiers are stored within the gateway P.

Automatic discovery mechanisms can also be set up, for example by means of a dedicated application installed on the terminal and designed to analyze the configuration of the terminal and provide a list of web applications configured on the interface of the terminal, to the gateway P.

Such an automatic discovery mechanism can be based on the SSDP (Simple Service Discovery Protocol) protocol developed by the UPnP (Universal Plug and Play) forum designed to allow the networked terminals to communicate and discover each other.

The previous requests from the terminal to the domain name system, DNS, can be analyzed to check whether they concern an identifier of a web application contained in an application database DB. This database is contained in the gateway P or is external and functionally connected to it.

If a request concerns an identifier of a web application stored in the database DB, then it can be inferred that a call to the web application is configured, or present, on the terminal T. The remote web server, which hosts the web application, is also directly inferred: its URL is inferred from the content of the application database and its IP address is inferred from the domain name system response.

If the gateway P detects the presence of a call to a web application A, then, a step S2 provides for the determination of a time period corresponding to low traffic associated with the remote server S hosting this web application A.

According to one embodiment, this traffic corresponds to a load on said remote web server. It can indeed be considered that the server load is directly impacted by the traffic generated by the different terminals sending requests to it. The server load is an indicator of its ability to respond quickly to each request and therefore directly impacts the quality of service (QoS) it provides, and therefore the speed of execution of the web applications and the latency involved in these executions.

This load can be an estimated load. This estimated load can be determined by the gateway without the need to query the remote web server (such a query would contribute to the server load and would adversely affect the latency of the execution of the web application).

This estimated load can be determined statistically.

For example, it can be established that during the course of a day, statistically, the load is low in some time slots (at night for example) and high in some other time slots. Such a statistic can correspond to an average of the rhythms of life of the users of the web applications concerned.

A time period corresponding to a low traffic for the remote web server can thus be determined, the term “low” referring to a lower relative value compared to the values taken during a cycle, for example daily cycle.

In a step S3, at least part of all the resources associated with the web application is downloaded during such a time period. In a particular case, all resources can be downloaded.

If the determination of the time period is performed according to a rule common to a set of gateways, then they can all trigger downloads at the same time. Insofar as this period corresponds to a period of non-use of the web application, the latencies that may thus be generated do not pose any particular problems.

It can also be designed to introduce a random element so that each gateway triggers the download at a distinct instant within the time period, in order to avoid these overloads of the remote web server S.

As illustrated in the example in FIG. 3, the download can be triggered by a request m1 transmitted by the gateway to the remote web server A, associated with the web application A.

In response, the remote web server S transmits the part (which may be the entirety in a particular case) of all the resources associated with the web application A, in one or several messages m2.

According to one embodiment (illustrated by this FIG. 3), the downloaded part is stored on an internal, or local, web server, SL, associated with the gateway P. The downloaded resources can keep an identifier similar to that on the remote web server S.

According to one embodiment, the downloaded part constitutes the entire resources associated with the web application A.

According to another embodiment, the downloaded part constitutes a specific subset of all the resources associated with the web application A.

Particularly, this part may correspond to the static resources associated with the web application. These static resources are those that are unlikely to be changed in the short term. The “short term” can correspond to the periodicity of the downloads of the resources. For example, if the gateway is designed to download the resources every day (in a time period determined in step S2), then if a resource is unlikely to be modified during the day, it can be considered as a static resource. Examples of static resources can be the logos, illustrative images, JavaScript codes, CSS (Cascading Style Sheet) type formatting codes, etc.

According to one embodiment, the recovery can be carried out resource by resource. For example, the gateway transmits a request m1 for each resource and the server transmits said resource in response in as many messages m2.

According to another embodiment, the resources are transmitted, for example in compressed form, in a single file. This file, or archive, can be constructed by the remote web server and made available to the gateways. A single request m1 to this file makes it possible to trigger its recovery using a single message m2.

This embodiment seems more interesting because it involves fewer requests on the network and also allows, when constructing the file, specifying which resources are considered static.

The format of the request ml can be that of a Classic Web request. It can therefore be, for example, a “GET” request from the HTTP protocol intended for the desired resource. This resource is identified by an address comprising a domain name (corresponding to the remote web server) and a resource name. This resource name can comprise the name of the web application A, depending on various implementation details accessible to those skilled in the art.

For example, an image resource can have the address:
www.monserveur.fr/monapplication/ressource.jpeg

In the case of a file grouping a set of resources, the address can be of the type:
www.monserveur.fr/monapplication/archive.tgz
or
www.monserveur.fr/archive.tgz

“tgz” is here one example of a compressed file extension (archive file created with tar and then compressed with gzip, generally on a Unix-type operating system).

According to embodiments, a step S4 of intercepting a request m6 is implemented. This step S4 can take place when turning on or activating a terminal T or in any other situation triggering access to the web application A. This step S4 is likely to be triggered concurrently on numerous gateways P. This is therefore a moment of potentially significant traffic for the remote web server S, but strongly limited by the exposed method.

Still other mechanisms can be deployed to use the anticipated download mechanism previously described.

In this step S4, the gateway P receives and intercepts a request m6 from the terminal T to a resource among the part of the set of resources which has been previously downloaded, and transmits, via one or several messages m8, the corresponding resource to the request (and which has been previously downloaded) to the terminal, without requesting the remote web server S.

In one embodiment (illustrated by FIG. 3), the gateway P in fact transmits the request to the internal (or local) web server SL, message m7, and it is the one that transmits the resource(s) to the terminal T, in accordance with the HTTP protocol.

When the downloaded part of the resources forms a proper (or strict) subset of the set of resources, the gateway P can receive messages m3 and transmit them, in a conventional manner, to the remote web server S, message m4, when they concern non-downloaded resources (that is to say belonging to the complementary set of the downloaded part). In which case, the remote web server S transmits the requested resources, in one or several messages m5, to the terminal T, in accordance with the HTTP protocol.

Typically, a first request m3 relates to a resource which itself can reference other resources. An exchange between a terminal and a web server therefore generally comprises a set of requests and responses (which normally contain the requested resource corresponding to a request).

For example, a first request m3 can relate to an “index.html” resource.

The html (HyperText Markup Language) file contains references to other resources: Java scripts (“framework.js”, “polyfill.js”, “main.js”), style sheets in CSS format (“style.css”), data in JSON format (“JavaScript Object Notation”, “config.json”), images (“desk.jpeg”, “play.png”, “ads.jpg”).

On receipt of the main file “index.html”, the terminal T parses its content to determine the referenced resources and, if it does not already have them in its own cache memory, transmits new requests m3, m6 to the gateway. These referenced resources may themselves contain other references to resources which, in turn, will follow the same process to be downloaded.

The gateway P can determine whether the requested resource corresponds to a resource available to it (that is to say that it has previously downloaded in step S3) or not.

FIG. 4 illustrates a concrete but simplified case of resource recovery by the terminal T both from the gateway P and the remote web server S. In this illustration, only the downloads are represented but each download is triggered by a request from the terminal T.

In this example, it is noted that a substantial part of the resources associated with the application A are downloaded from the gateway P, and not from the remote server P. The latter is thus relieved of a significant load.

Generally, the method makes it possible to avoid concurrent downloads of too large a number of resources from a plurality of terminals. This avoids overloading the web servers hosting the web applications. For the terminals, better quality of service is obtained during the execution of the web applications, in particular materialized by better latency and greater speed of execution. The request of the web servers is also better distributed, including during the periods of underuse. These web servers can thus be sized optimally in a way that respects good energy management.

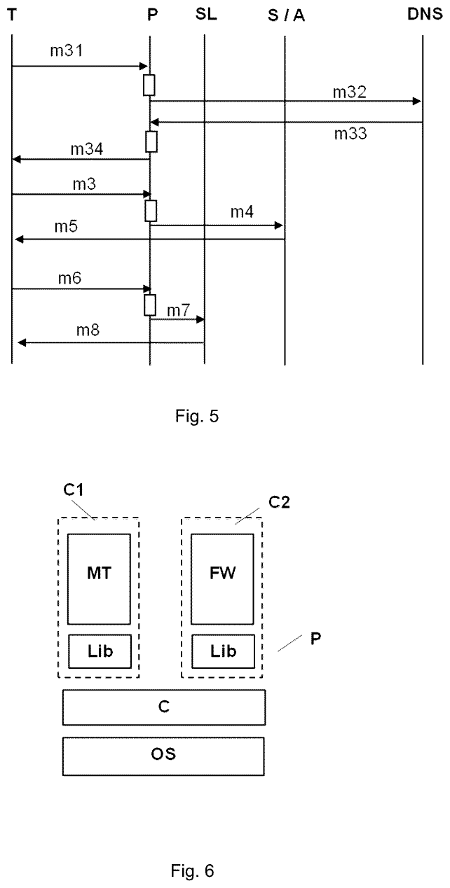

FIG. 5 represents a timing diagram illustrating one particular embodiment of step S3 of the proposed method, based on an interaction with a domain name server DNS.

The terminal T knows a logical address of the remote web server S, hosting the web application A, but not its physical address. In order to be able to request a resource, it must therefore query a domain name server DNS, message m31.

The gateway redirects this request to a DNS server, then transmits its response m33 to the terminal T, message m34. This message is classic in itself, but it further allows the gateway to learn an association between the logical address and the physical address of the remote web server.

The gateway can thus determine the identifier of a resource from a request containing its physical address. Thus, from a physical address (IP address), it can determine an identifier based on the identification of the web application A.

Particularly, in one embodiment, the interception S4 comprises an analysis of a first request m31 from the terminal T intended for the domain name system, to determine whether this first request corresponds to the web application A and, in this case, a storage of an IP address corresponding to this first request (that is to say, in general, the address of the “destination” field of the message m31). Then, the detection of the requests m6 from said terminal to said resource to be intercepted is performed from the IP address.

Using the example cited previously, such a resource identifier can take the form: www.monserveur.fr/monapplication/ressource.jpeg (in the case of an image resource in JPEG format).

Thus, upon receipt of a request m3, addressed to the physical address of the web server A, the gateway A is able to determine the identifier of the requested resource and here, it does not have this resource. The request is retransmitted, m4, to the remote server S, thus triggering its download m5.

Upon receipt of the request m6, the gateway can determine the identifier of the required resource and that it has this resource (previously downloaded). It transmits the request, m7, to the local web server which can thus transmit the resource (previously downloaded), m8, to the terminal T. In this case, the remote web server is not requested.

FIG. 6 illustrates functional software architecture of a gateway P according to one particular embodiment implementing an application container.

Unlike the virtual machines, the containers do not emulate the hardware, but the operating system. Several isolated containers can be operated within an operating system installation.

As illustrated in FIG. 6, a container engine C can be deployed above the operating system, OS, implemented by the processing means TRT of the platform P.

Several containers C1, C2 can thus be deployed above the container engine C.

Each container can contain a library Lib allowing accessing the functionality of the container engine and ensuring the interface between the application MT, FW so that the software architecture based on containers is transparent to it.

The application FW is for example the firewall conventionally embedded on the gateway P.

The application MT represents the software means adapted to the implementation of the described method (that is to say, schematically, the software means of the processing means TRT, previously mentioned).

The use of containers brings a lot of flexibility such as: the sealing of the applications relative to each other, the possibility of easily adding a new web application cache service, the control of the resources used by the containers, etc.

According to one embodiment, virtual machines can be used instead of the containers.

Of course, the present invention is not limited to the examples and to the embodiment described and represented, but is defined by the claims. It is in particular subject to numerous variants accessible to those skilled in the art.

What is claimed is:

1. A method for executing, by a terminal, a web application whose set of associated resources is stored on a remote web server, the method including:
detecting, by a gateway, a presence within the terminal of a call to the web application and identifying the remote web server;
determining a time period corresponding to low traffic associated with the remote web server; and,
downloading at least part of the set of resources during the time period by the gateway.

2. The method according to claim 1, further including intercepting, by the gateway, a request from the terminal to a resource among the at least part of the set of resources, and transmitting the resource corresponding to the request to the terminal.

3. The method according to claim 2, wherein the interception operates in collaboration with an application container deployed on the gateway in order to isolate the processing within the gateway.

4. The method according to claim 1, wherein the at least part of the set of resources is stored on an internal web server of the gateway.

5. The method according to claim 1, wherein the at least part of the set of resources is made of static resources.

6. The method according to claim 1, wherein the traffic corresponds to a load of the remote web server.

7. The method according to claim 1, wherein the detection comprises an analysis of previous requests from the terminal to a domain name system based on an application database.

8. The method according to claim 7, further including intercepting, by the gateway, a request from the terminal to a resource among the at least part of the set of resources, and transmitting the resource corresponding to the request to the terminal, wherein the interception comprises an analysis of a first request from the terminal intended for the domain name system, to determine whether the first request corresponds to the web application and, in this case, a storage of an IP address corresponding to the first request, and detection of the request from the terminal to the resource from the IP address.

9. A gateway for executing, by a terminal, a web application whose set of associated resources is stored on a remote web server, the gateway including processing means adapted to:
detect a presence within the terminal of a call to the web application and identify the remote web server;
determine a time period corresponding to a low traffic associated with the remote web server; and
download at least part of the set of resources during the time period by the gateway.

10. The gateway according to claim 9, wherein the processing means are further adapted to intercept a request from the terminal to a resource among the at least part of the set of resources, and transmit the resource corresponding to the request to the terminal.

11. A computer program able to be implemented on a gateway, the computer program comprising code instructions which, when the computer program is executed by a processor, executes the method defined in claim 1.

12. A non-transitory computer readable data medium on which at least one series of program code instructions has been stored for executing the method according to claim 1.
